(19) United States
(12) Patent Application Publication
(10) Pub. No.: US 2016/0197534 A1
(43) Pub. Date: Jul. 7, 2016

(54) HVAC SYSTEM WITH ENERGY RECOVERY MECHANISM

(71) Applicants: Dennis Melvin WALKER, Gurnee, IL (US); Arthur Maurice Kubogamell, Morgan Hill, CA (US)

(72) Inventors: Dennis Melvin WALKER, Gurnee, IL (US); Arthur Maurice Kubogamell, Morgan Hill, CA (US)

(21) Appl. No.: 14/988,370

(22) Filed: Jan. 5, 2016

Related U.S. Application Data
(60) Provisional application No. 62/099,689, filed on Jan. 5, 2015.

(51) Int. Cl. H02K 7/18

(52) U.S. Cl. CPC H02K 7/1823; Y10S 415/916; F03B 17/005

(57) ABSTRACT

An electrically powered HVAC system for electric vehicles with a combined energy recovery powered electric generator is disclosed. The present invention is an improvement in that it incorporates a compact designed turbine and electrical power generator into the AC unit that is driven by energy recovered within the Rankine cycle loop. The unit's compact design yields a favorable power to weight ratio—its small turbine and generator package produces a lot of power for its light weight. Additionally, the invention requires no outside power source to drive the generator. Rather, the combined turbine/generator recovers energy from high pressure vapor as it flows through the turbine manifold where it causes the turbine/rotor which incorporates permanent magnets, to spin around the stator thus creating electricity. The electricity created is used to charge the auxiliary battery, operate the compressor and other electrical HVAC components, or power other low voltage systems within the vehicle.

### CROSS-REFERENCE TO RELATED APPLICATIONS

This application claims the benefit of priority to co-pending U.S. Provisional Patent Application Ser. No. 62/099,689 filed Jan. 5, 2015, which is herein incorporated by reference in its entirety.

### BACKGROUND OF THE INVENTION

The present invention pertains generally to the field of heating, ventilation and air conditioning (HVAC) systems for electric vehicles.

Most electric vehicles (EVs) have a 350 volt main battery and a 12 volt auxiliary battery which is powered by the main battery. The auxiliary battery is recharged with the use of a DC-to-DC converter. This electrical device provides power and charge to the 12-volt auxiliary battery from the high-voltage battery pack used to power the vehicle; a constant drain of the auxiliary battery results in a constant drain on the main batter, thus adversely affecting driving range.

EV HVAC systems such as electric heating, ventilation, air conditioning (AC) and other accessories are generally powered by the EV's auxiliary battery. The HVAC unit's heating and air conditioning demand the most significant amount of electrical power for operation, and therefore place a tremendous drain on the battery systems. The high demand and load that the HVAC system places on the vehicle's battery system can have a significant negative impact on a vehicle's driving range because powering the HVAC system leaves less energy to power the systems needed to actually drive the car. The challenge remains to reduce the HVAC power load so that running the AC does not overly drain the battery and reduce vehicle range.

While solar photovoltaic cells could be a power source to drive the compressor motor and reduce the load on the battery system, photovoltaic cells are expensive, fragile and require quite a large surface area to produce the needed power. Therefore it would not be practical to use photovoltaic cells to generate power for EV HVAC systems.

While fuel cells could be a power source to drive the compressor motor and reduce the load on the battery system, fuel cells are expensive and not readily available. Additionally, using fuel cells to provide power for the compressor and other components is a disruptive technology as it requires a combustion chamber and other complicated modifications be made to the conventional electric HVAC system. High cost, scarcity, and complexity minimize the practicality of using fuel cells to generate power for EV HVAC systems.

Compressors in conventional gasoline powered vehicles are driven by an engine's belt drive, but EVs do not have belt-driven engines that energize the peripheral systems and subsequently, belt driven compressors are not an acceptable option in electric vehicles.

The present invention reduces the electrical power requirement of the HVAC load from the primary battery once the AC unit is activated. Resolving this will directly address the limited driving range issue which has been one of the major influences constraining consumer acceptance of electric vehicles.

### SUMMARY OF THE INVENTION

The present invention is an improvement over existing EV HVAC systems in that it incorporates a compact designed turbine and electrical power generator into the AC unit that is driven by energy recovered within the Rankine cycle loop. This compact design yields a favorable power to weight ratio—its small turbine and generator package produces a lot of power for its light weight. Subsequently, it produces adequate electrical power without adding excessive weight to the vehicle that would adversely affect its efficiency and therefore range.

The present invention reduces the HVAC load from the primary battery by generating electrical energy to supplement the recharging of the auxiliary battery system by means of a slow trickle charge. In this manner, the recharging via DC-to-DC conversion from the primary to the auxiliary battery that normally occurs, and the frequency of battery charging may be reduced, therefore extending vehicle range and the life of the battery systems.

It is another object of the present invention to use the turbine electrical power generator to directly power the AC unit, other electrically powered components within the HVAC system and other low voltage systems within the vehicle.

The claimed invention differs from what currently exists. The present invention is an electrically powered HVAC system with a combined energy recovery powered electric generator for Electric Vehicles that reduces the HVAC load from the primary battery by generating electrical energy to supplement recharging the auxiliary battery system by means of a slow trickle charge when the battery's state of charge is low and can accept a charge, and to run the vehicles low voltage systems.

This invention is an improvement on what currently exists because the present invention does not require an outside power source to drive the generator. The combined turbine/generator recovers energy from the high pressure vapor within the Rankine cycle loop as it flows through the turbine manifold where it causes the turbine/rotor that incorporates a series of permanent magnets to spin around the stator thus creating electricity.

### BRIEF DESCRIPTION OF THE DRAWINGS

FIG. 1 is a diagram the operation of an HVAC unit with combined energy recovery mechanism;

FIG. 2 is a diagram of an alternate embodiment of the operation of an HVAC unit with combined energy recovery mechanism

### DETAILED DESCRIPTION OF THE PREFERRED EMBODIMENTS

Electric AC units of EV HVAC systems are generally comprised of a working fluid (the fluid refrigerant that circulates through the air-conditioning system), a compressor, a condensing coil, a metering device and an evaporator. The present invention adds an additional component, a turbine electric generator (TEG) which is used to generate an alternating current.

Operating within a closed loop system, at times the refrigerant will be both a liquid and a vapor within the loop. The change of state of the refrigerant offers opportunity to transfer energy. The present invention uses energy recovered from the gases under pressure as the power source to drive a turbine electric generator that generates an alternating current used to charge the auxiliary battery and operate other components within the HVAC system such as the compressor which is electrified and has its own motor, inverter and circuit board.

The TEG is installed on the high pressure side of an electrically powered AC system. After the compressor compresses the low pressure refrigerant vapor into a high pressure vapor and passes through the discharge line it flows through the turbine electric generator. As the gas under pressure flows through the turbine electric generator it creates an alternating current that is used to charge the auxiliary battery and operate the compressor which is electrified and has its own motor, inverter and circuit board.

An AC to DC converter facilitates the conversion of the alternating currenet output of the TEG to a direct current for storage in the battery and to match the specifications required to operate components of the electric HVAC system.

The TEG is fitted with a connector on the intake side that interfaces with the discharge line on the high pressure side of the compressor of an electric powered air conditioner system and the refrigerant loop. The TEG is additionally fitted with a connector on its exhaust side that interfaces with the refrigerant loop on the high pressure side of the compressor continuing on to the condenser.

Once the TEG is connected within the refrigerant loop it forms a closed loop system through which high pressure vapor passes from the compressor discharge line and flows through the turbine electric generator. As the gas under pressure flows through the turbine electric generator it has sufficient pressure to cause the rotor to spin around the stator generating and outputting an alternating current. The gas under pressure then continues along its path through the closed loop continuously repeating the cycle.

Electronic control modules, microprocessors, relays, and other circuity control the flow of alternating current from the TEG to the auxiliary battery storage device and electrical HVAC components to be powered. The energy recovered can be used to charge the auxiliary battery and operate the compressor which is electrified and has its own motor, inverter and circuit board. The power generated is also used to run other low voltage systems within the vehicle.

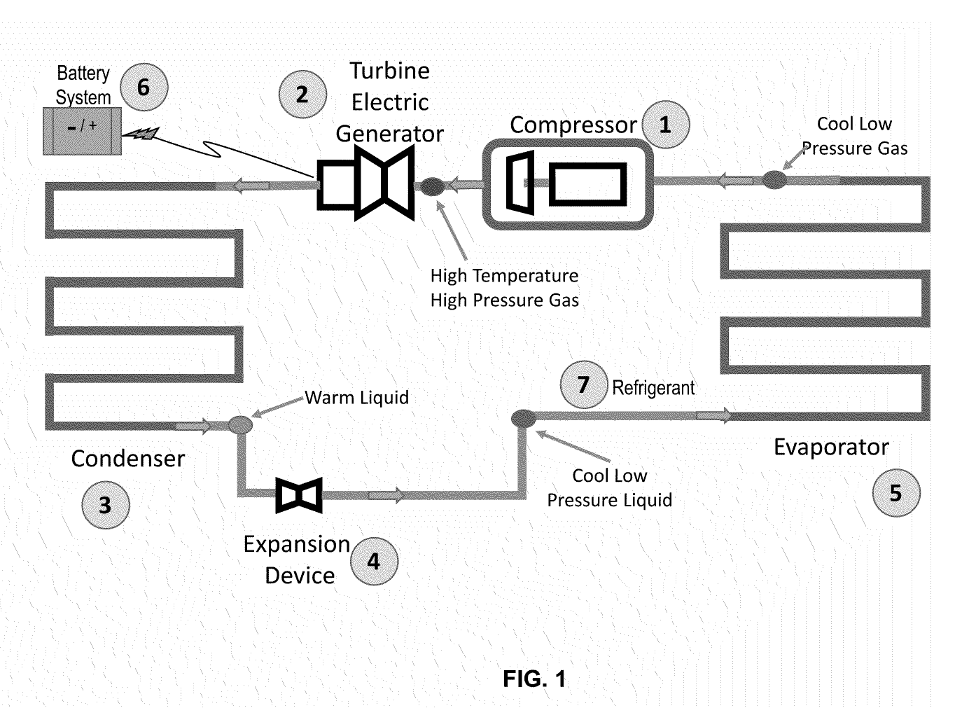

With specific reference to the drawings, FIG. 1 in its entirety represents an electrically powered HVAC system for electric vehicles with a combined energy recovery powered electric generator. The system substantially comprises a compressor 1, a turbine electric generator (TEG) 2, the electric vehicle's battery system 6, a condenser 3, a filter dryer thermal expansion valve 4, an evaporator 5, and refrigerant 7.

FIG. 1 depicts low pressure vapor refrigerant 7 flowing through the compressor 1, being compressed and discharged as high pressure vapor/gas through the discharge line of the compressor 1 and through the intake of a turbine electric generator (TEG) 2. The TEG 2 recovers energy from the high pressure vapor as it flows through the turbine manifold where it causes the turbine/rotor that incorporates a series of permanent magnets to spin around the stator thus creating electricity. The TEG 2 is coupled to the electric vehicle's battery system 6 and provides a slow trickle charge to the system 6 as the high pressure vapor/gas flows through the TEG 2. The high pressure then vapor exits the TEG 2 exhaust and flows through the condenser 3. The condenser changes the high pressure refrigerant from a high temperature vapor to a low temperature, high pressure liquid and the refrigerant leaves through the liquid line. From the liquid line, the high pressure refrigerant exits the condenser 3 and flows through a filter dryer thermal expansion valve 4 which meters the correct amount of refrigerant into the evaporator 5.

As the thermal expansion valve meters the refrigerant, the high pressure liquid changes to a low pressure, low temperature, and saturated liquid/vapor. The refrigerant 7 in the saturated liquid/vapor form enters the evaporator 5 and is changed to a low pressure dry vapor where the cycle begins again. Electrical power is continuously generated by the TEG and stored in the auxiliary battery or used to power electrical components of the HVAC system.

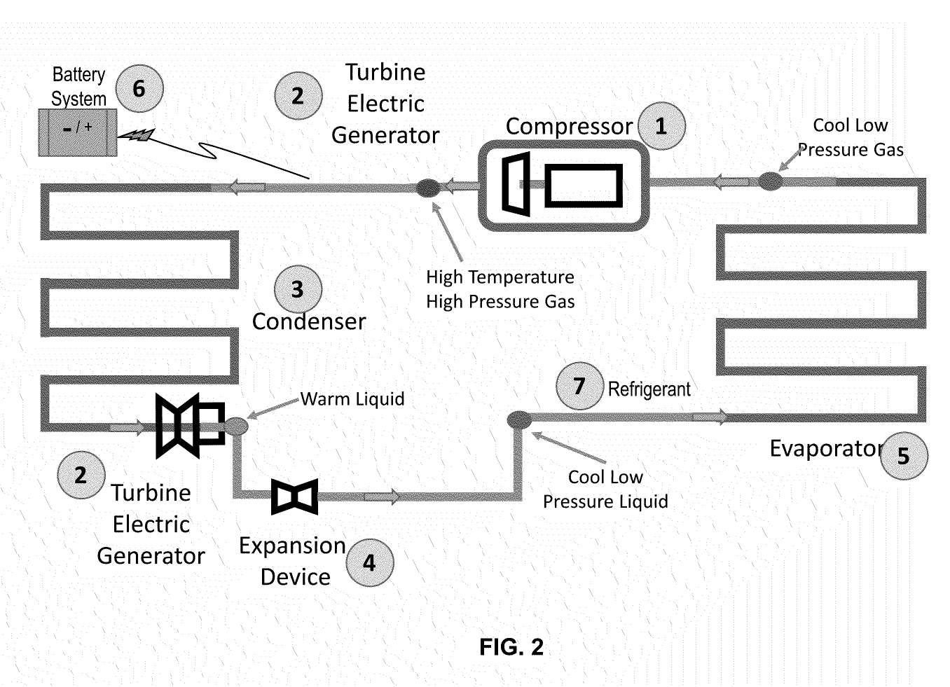

FIG. 2 depicts an alternate embodiment where the low pressure vapor refrigerant 7 flows through the compressor 1 and is discharged as high pressure vapor/gas through the condenser 3, the high pressure refrigerant exits the condenser 3 and flows through a TEG 2, the TEG 2 is coupled to the electric vehicle's battery system 6 and provides a slow trickle charge to the system 6 as the high pressure vapor/gas flows through the TEG 2. As the high pressure vapor exits the

TEG 2 exhaust and flows through a filter dryer thermal expansion valve 4 which meters the correct amount of refrigerant into the evaporator 5. The refrigerant 7 in a saturated liquid/vapor form enters the evaporator 5 and is changed to a low pressure dry vapor where the cycle begins again.

The present invention can be made by way of the conventional process of manufacturing an electric vapor compression HVAC system (air conditioners) for an EV. The difference would be incorporating the TEG into the manufacturing and assembly process. This is done by attaching the fitted connector on the intake side of the assembled TEG such that it interfaces with the discharge line on the high pressure side of the compressor of an electric powered air conditioner system and the refrigerant loop. Then attaching the fitted connector on the exhaust side of the TEG such that it interfaces with the refrigerant loop on the high pressure side of the compressor continuing on to the condenser.

Fundamental to manufacturing the present invention would be the use of different types of corrosion-resistant metals, plastic and other nontraditional materials to ensure durability, reduce weight and lower cost. Copper or aluminum tubing, will be used to make some components, as they provide superior thermal properties and positively influence system efficiency.

The first step of the manufacturing process would be sourcing the parts and components that are pre-made and readily available off the shelf. This includes components such as the condensers, compressors, the expansion valves and the evaporators.

Secondly, the manufacturing process would entail fabricating the metal and any plastic parts that are not readily available off the shelf. Most of these would be custom metal parts for the Turbine Electric Generator (TEG), which would be machined while others may be stamped from sheet metal to give them the desired shape and size. Any plastic pieces would be vacuum formed or cast.

Once the invention has been assembled, the refrigerant is placed in the compressor, condensers and closed loop system to a pre-determined pressure level. The unit would then be tested for coolant leak, electronic controls function properly, and TEG electric output meets design specs.

It is necessary for the present invention to be comprised of a working fluid, a compressor, a condensing coil, a metering device, an evaporator, a compact turbine electric generator (TEG), and an auxiliary battery storage system in order to provide electrical power to the auxiliary battery system and other electrically powered components of an electric HVAC system for EVs, as previously described.

It is possible to achieve the same results claimed by the present invention by reconfiguring elements of the present invention such that all the components used are the same except the turbine electric genset. Instead of the compact turbine electric generator (TEG) package incorporated into the present invention, a separate turbine with a shaft connected to a separate generator with shaft, could be used. Wherein the spinning shaft of the turbine would cause the shaft connected to the generator to turn thus creating electricity.

The present invention facilitates the supply of power to the compressor to allow the compressor to continue to work when the vehicle is stopped and doesn't require a more powerful drive motor to run when the car isn't moving. It does this without creating an extra load on the batteries reducing the vehicle's overall range.

The present invention can also be used in the tractor trailer/semi-truck and Motor Home/RV markets. Higher fuel costs, and stricter environmental and idling regulations, are motivating tractor trailer/semi-truck fleets and Motor Home/RV owners to take varied measures to save fuel wasted while idling. The present invention can be used as an idle reduction solution to supplement the power needed for APUs (auxiliary power heating and cooling units) that power electric HVAC systems of Tractor Trailer trucks and Motor Home/RVs as these electric HVAC systems incorporate the same fundamental components, (refrigerant, the compressor, the condensing coil, the metering device and the evaporator) that comprise the conventional EV HVAC system. Subsequently, incorporating the present invention into the core components of these Electric HVAC systems, as previously described, will produce the benefits of reducing load demand on the battery system, providing a charging source for the battery, reducing vehicle operating cost and reducing emission of greenhouse gases.

The present invention can be used to improve the performance of emerging Electric PCM (Phase Change Material) Assisted Thermal Heating System electric vehicle technology as these incorporate some of the same fundamental components, (refrigerant, the compressor, the condensing coil, the metering device and the evaporator) that comprise the conventional EV HVAC system. Subsequently, incorporating the present invention into the core components of these Electric Phase Change Material Assisted Thermal Heating Systems, as previously described, will produce the benefits of reducing load demand on the primary battery and extending vehicle range that are seen in the present invention.

The charging rate of the battery system greatly exceeds the discharging rate thus improving the duty cycle—as the percentage of time that current flows from the generator is directly proportional to the specific period of time the HVAC system is operated.

The present invention is an efficient form of converting gases under pressure into electrical energy. Additionally, since the gases under pressure only flow through the TEG there is no adverse effect on the gases as they continue through the closed loop system.

The present invention can be used to improve the performance of electric heat pumps being used in electric vehicles. Considering that a heat pump is essentially an AC system (with an extra valve that allows hot side condenser coil and the cold side evaporator coil to reverse places depending upon whether hot or cold air is required), these incorporate some of the same fundamental components, (refrigerant, the compressor, the condensing coil, the metering device and the evaporator) that comprise the conventional EV HVAC system. Subsequently, incorporating the present invention into the core components of these electric heat pumps being used in electric vehicles, as previously described, will produce the benefits of reducing load demand on the primary battery and extending vehicle range that are seen in the present invention.

What is claimed:

1. An HVAC unit comprising:
a. a compressor, coupled through an exhaust to a turbine electric generator;
b. the turbine electric generator electrically coupled to an AC to DC converter, the converter electrically coupled to a power supply;
c. the turbine electric generator also coupled through an exhaust to a condenser;
d. the condenser coupled through an exhaust to a filter dryer thermal expansion valve;
e. the expansion valve coupled through an exhaust to an evaporator; and
f. the evaporator coupled through an exhaust to an intake of the compressor.

2. The turbine electric generator of claim 1 having a turbine or rotor incorporating a series of permanent magnets and a stator.

3. The compressor of claim 2 electrically coupled to and powered by the same power supply that is electrically coupled to the AC to DC converter and turbine electric generator.

4. The exhausts and intakes of claim 1 made from a material of with enhanced thermal properties such as copper or aluminum tubing.

5. The HVAC unit of claim 3, wherein the HVAC unit is additionally electrically coupled to a main power supply of an electric vehicle.

6. The HVAC unit of claim 3, wherein there is an extra valve coupled to the loop that allows a hot side of a condenser coil and the cold side evaporator coil to reverse forming a heat pump.

7. A method for generating electricity using an HVAC system comprising:
a. discharging a low pressure vapor refrigerant through a compressor, compressing the low pressure vapor refrigerant into high temperature, high pressure vapor;
b. discharging the high pressure vapor under high pressure flow through a turbine electric generator, having a turbine or rotor that incorporates a series of permanent magnets and a stator, electrically coupled to an AC to DC converter and a power supply, the high pressure vapor causing the turbine or rotor and magnets to rotate around the stator, thereby generating an alternating current;
c. converting the alternating current to direct current with the electrically coupled AC to DC converter, and using the direct current to charge the power supply;
d. discharging the high pressure vapor through the turbine electric generator exhaust into a condenser;
e. condensing the high pressure refrigerant from a high temperature vapor to a low temperature, high pressure liquid, and discharging the high pressure liquid through a filter dryer thermal expansion valve which meters the correct amount of refrigerant into the evaporator, while changing the high pressure liquid to a low pressure, low temperature, and saturated liquid and vapor;
f. evaporating the saturated liquid and vapor into a low pressure dry vapor.

8. The method for generating electricity of claim 7, wherein the compressor, turbine electric generator, condenser, expansion device, and evaporator form a closed loop.

9. The method for generating electricity of claim 8, wherein the after the step of evaporating the saturated liquid and vapor into a low pressure dry vapor is completed, the low pressure dry vapor is discharged into the compressor, thereby restarting the loop.

10. The method for generating electricity of claim 9, wherein the power supply is also electrically coupled to the compressor and is used to supply power to the compressor.

11. The method for generating electricity of claim 10, wherein the power supply is also electrically coupled to a main power supply of an electric vehicle.

12. The method for generating electricity of claim 10, wherein there is an extra valve coupled to the loop that allows a hot side of a condenser coil and the cold side evaporator coil to reverse, forming a heat pump.
